(19) United States
(12) Patent Application Publication
(10) Pub. No.: US 2012/0263230 A1
(43) Pub. Date: Oct. 18, 2012

(54) IMAGE CODING APPARATUS AND INTEGRATED CIRCUIT

(75) Inventors: Kotaro ESAKI, Osaka (JP); Tsutomu HASHIMOTO, Kyoto (JP)

(73) Assignee: PANASONIC CORPORATION, Osaka (JP)

(21) Appl. No.: 13/534,863

(22) Filed: Jun. 27, 2012

Related U.S. Application Data
(63) Continuation of application No. PCT/JP2010/004558, filed on Jul. 14, 2010.

(30) Foreign Application Priority Data
Dec. 28, 2009 (JP) 2009-298931

(51) Int. Cl. H04N 7/30

(52) U.S. Cl. 375/240.03; 375/E07.226

(57) ABSTRACT

An image coding apparatus includes a binarizing unit which generate binary data corresponding to quantized data, and an arithmetic coding unit which generate a stream corresponding to the binary data. In the image coding apparatus, one or both of the binarizing and the arithmetic coding are performed. The binarizing is performed by the binarizing unit alternately on first quantized data and second quantized data, using a time division technique. The arithmetic coding is performed by the arithmetic coding unit alternately on first binary data and second binary data, using the time division technique.

### CROSS REFERENCE TO RELATED APPLICATIONS

This is a continuation application of PCT Patent Application No. PCT/JP2010/004558 filed on Jul. 14, 2010, designating the United States of America, which is based on and claims priority of Japanese Patent Application No. 2009-298931 filed on Dec. 28, 2009. The entire disclosures of the above-identified applications, including the specifications, drawings and claims are incorporated herein by reference in their entirety.

### TECHNICAL FIELD

The present invention relates to an image coding apparatus and an integrated circuit which generate multiple kinds of streams.

### BACKGROUND ART

One of the currently appealing image processing techniques is for generating multiple kinds of streams. For example, Patent Reference 1 discloses a technique for simultaneously generating streams compressed at a low bit rate and at a high bit rate (Hereinafter referred to as “conventional technique A”).

### CITATION LIST

### Patent Literature

[PL1] Japanese Unexamined Patent Application Publication No. 2008-160494

### SUMMARY OF INVENTION

### Technical Problem

The recent mainstream of coding schemes for moving pictures is that image coding schemes comply with the H.264/AVC standard (Hereinafter referred to as H.264 coding scheme). The H.264 coding scheme improves its coding efficiency by processing a block in a variable size, performing motion compensation with quarter-pixel precision, and executing arithmetic coding.

Since the H.264 coding scheme involves a significant amount of computations in coding of moving pictures, the format requires dedicated hardware when the image has to be coded on a real-time basis. Hereinafter, the coding hardware that complies with the H.264 coding scheme is referred to as H.264 coding circuit.

Hence, when the H.264 coding scheme is used for generating multiple kinds of streams, multiple H.264 coding circuits may be separately arranged in parallel in an image coding apparatus. The problem here, however, is that the circuit scale of the image coding apparatus which generates multiple kinds of streams becomes significantly large.

The present invention is conceived in view of the above problem and has an object to implement an image coding apparatus whose circuit scale is reduced and which performs arithmetic coding and generates multiple streams.

### Solution to Problem

In order to solve the above problem, an image coding apparatus according to an aspect of the present invention the video coding apparatus performs at least discrete cosine transform, quantization, and arithmetic coding, and processes pieces of first quantized data and pieces of second quantized data obtained by the quantization. The image coding apparatus includes: a binarizing unit which binarizes the pieces of the first quantized data and the pieces of the second quantized data to generate pieces of first binary data and pieces of second binary data, the pieces of the first binary data each corresponding to one of the pieces of the first quantized data and the pieces of the second binary data each corresponding to one of the pieces of the second quantized data; and an arithmetic coding unit which performs arithmetic coding on each of the pieces of the first binary data and each of the pieces of the second binary data to generate a first stream and a second stream corresponding to the pieces of the first binary data and the pieces of the second binary data, respectively. In the image coding apparatus, one or both of the binarizing and the arithmetic coding are performed. The binarizing is performed by the binarizing unit alternately on the first quantized data and the second quantized data using a time division technique, and the arithmetic coding is performed by said arithmetic coding unit alternately on the first binary data and the second binary data using the time division technique.

Thus, the above feature successfully reduces the circuit scale of the image coding apparatus. Furthermore, the arithmetic coding unit performs the arithmetic coding to generate the first stream and the second stream. Hence, the aspect of the present invention successfully implements an image coding apparatus whose circuit scale is reduced and which performs arithmetic coding and generates multiple streams.

Preferably, the binarizing unit alternately binarizes the first quantized data and the second quantized data using the time division technique, and the arithmetic coding unit performs the arithmetic coding alternately on the first binary data and the second binary data using the time division technique.

Preferably, the image coding apparatus further includes a first memory and a second memory. Preferably, the arithmetic coding unit further stores the first stream and the second stream in the first memory and the second memory, respectively.

The above feature makes it possible to independently store each of the first stream and the second stream in a different memory.

Preferably, the image coding apparatus further includes a third memory and a fourth memory. Preferably, the binarizing unit further stores each of the pieces of the first binary data and each of the pieces of the second binary data in the third memory and the fourth memory, respectively. Each of the pieces of the first binary data and each of the pieces of the second binary data is subject to the arithmetic coding.

Preferably, the binarizing unit alternately binarizes the first quantized data and the second quantized data using the time division technique.

Preferably, the image coding apparatus further includes a first memory and a second memory. The arithmetic coding unit further includes: a first arithmetic coding unit; and a second arithmetic coding unit. Preferably, the first arithmetic coding unit performs the arithmetic coding on the pieces of the first binary data to generate the first stream, and stores the generated first stream in the first memory, and the second arithmetic coding unit performs arithmetic coding on the pieces of the second binary data to generate the second stream, and stores the generated second stream in the second memory.

The above feature makes it possible to independently store each of the first stream and the second stream in a different memory.

Preferably, the arithmetic coding complies with the H.264/AVC standard, the binarizing performed by the binarizing unit is based on context-adaptive binary arithmetic coding, and the arithmetic coding performed by the arithmetic coding unit is binary arithmetic coding based on the context-adaptive binary arithmetic coding.

Preferably, the first quantized data and the second quantized data are obtained from two different moving pictures.

Preferably, the first quantized data and the second quantized data are obtained from two different moving pictures.

An integrated circuit according to another aspect of the present invention performs at least the discrete cosine transform, quantization, and arithmetic coding, and processes pieces of the first quantized data and the second quantized data obtained by the quantization. The integrated circuit includes: a binarizing unit which binarizes the pieces of the first quantized data and the pieces of the second quantized data to generate pieces of first binary data and pieces of second binary data, the pieces of the first binary data each corresponding to one of the pieces of the first quantized data and the pieces of the second binary data each corresponding to one of the pieces of the second quantized data; and an arithmetic coding unit which performs arithmetic coding on each of the pieces of the first binary data and each of the pieces of the second binary data to generate a first stream and a second stream corresponding to the pieces of the first binary data and the pieces of the second binary data, respectively. In the integrated circuit, one or both of the binarizing and the arithmetic coding are performed. The binarizing is performed by the binarizing unit alternately on the first quantized data and the second quantized data using a time division technique, and the arithmetic coding is performed by the arithmetic coding unit alternately on the first binary data and the second binary data using the time division technique.

It is noted that in the present invention, part or all of the constituent elements constituting the image coding apparatus may be configured from a single System-LSI (Large-Scale Integration).

Furthermore, an aspect of the present invention may be implemented as an image coding method including the operations of the characteristic units as steps. In addition, the present invention may be implemented as a program to cause a computer to execute each of the steps included in the image coding method. Furthermore, the present invention may be implemented as a computer-readable recording medium which hold the program. In addition, the program may be distributed via a transmission medium such as the Internet.

### Advantageous Effects of Invention

The present invention successfully implements an image coding apparatus whose circuit scale is reduced and which performs arithmetic coding and generates multiple streams.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 is a block diagram showing a structure of an image coding apparatus according to an embodiment;

FIG. 2 shows two kinds of moving pictures;

FIG. 3 is a block diagram showing a structure of the image coding unit according to the embodiment;

FIG. 4 is a block diagram showing a structure of a variable length coding unit according to the embodiment;

FIG. 5 is a block diagram showing a structure of an image coding apparatus according to Modification 1 of the embodiment;

FIG. 6 is a block diagram showing a structure of an image coding unit according to Modification 1 of the embodiment;

FIG. 7 is a block diagram showing a structure of a variable length coding unit according to Modification 1 of the embodiment;

FIG. 8 is a block diagram showing a structure of an image coding apparatus according to Modification 2 of the embodiment;

FIG. 9 is a block diagram showing a structure of an image coding unit according to Modification 2 of the embodiment;

FIG. 10 is a block diagram showing a structure of a variable length coding unit according to Modification 2 of the embodiment;

FIG. 11 is a block diagram showing a structure of an image coding apparatus according to Modification 3 of the embodiment;

FIG. 12 is a block diagram showing a structure of an image coding unit according to Modification 3 of the embodiment;

FIG. 13 is a block diagram showing a structure of a variable length coding unit according to Modification 3 of the embodiment; and

FIG. 14 is a block diagram showing a characteristic functional structure of an image coding apparatus.

### DESCRIPTION OF EMBODIMENT

Described hereinafter is an embodiment of the present invention with reference to the drawings. In the description below, the same constitutional elements have a uniformed numerical reference. The names and the functions thereof are uniform. Hence, the details of the constitutional elements shall not be repeated.

### Embodiment

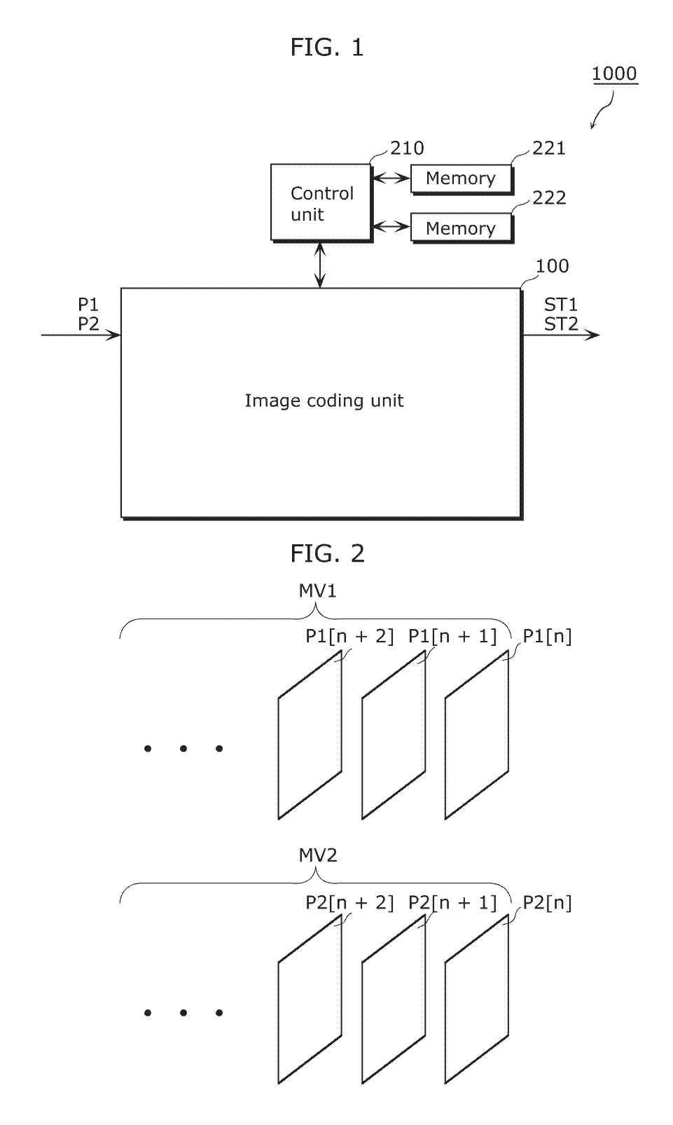

FIG. 1 is a block diagram showing a structure of an image coding apparatus 1000 according to an embodiment.

As shown in FIG. 1, the image coding apparatus 1000 includes an image coding unit 100, a control unit 210, and memories 221 and 222.

Each of the memories 221 and 222 (dynamic random access memory (DRAM), for example) stores data. It is noted that each of the memories 221 and 222 does not have to be separately provided. Each of the memories 221 and 222 may be provided as a storage region included in a single memory.

The control unit 210 includes a processor such as a central processing unit (CPU, not shown) and a memory control circuit (not shown). The processor of the control unit 210 controls operations of the image coding unit 100.

Furthermore, the memory control circuit of the control unit 210 accesses the data in the memories 221 and 222. The data to be stored in the memories 221 and 222 is not transferred via the processor but only via the memory control circuit for its storage. The data to be read from the memories 221 and 222 is not transferred via the processor but only via the memory control circuit for its reading out.

Hereinafter, the processor of the control unit 210 that controls the image coding unit 100 and after-described image coding units 100A, 1006, and 100C is referred to as the control unit 210 as a whole.

The image coding unit 100 encodes moving pictures according to a predetermined image coding scheme. The image coding scheme complies with the H.264/AVC standard. It is noted that the image coding scheme shall not be limited to the H.264/AVC standard; instead, the image coding scheme may comply with another standard as far as the coding scheme involves arithmetic coding.

The image coding unit 100 receives pictures P1 forming a moving picture MV1 and pictures P2 forming a moving picture MV2. It is noted that the image coding unit 100 may receive either the moving picture MV1 or the moving picture MV2 instead of both of the moving pictures MV1 and MV2.

FIG. 2 illustrates the moving pictures MV1 and MV2. Each of the moving pictures MV1 and MV2 includes moving pictures for a different piece of content (such as a show on a different channel).

Hereinafter, the n-th picture P1 (n is an integer) is also referred to as a picture P1 [n]. The n-th picture P2 (n is an integer) is also referred to as a picture P2 [n].

As shown in FIG. 2, the moving picture MV1 is formed of pictures P1 [n], P1 [n+1], P1 [n+2] . . . . The moving picture MV2 is formed of pictures P2 [n], P2 [n+1], P2 [n+2] . . . .

The image coding unit 100 alternately receives pictures P1 in the moving picture MV1 and pictures P2 in the moving picture MV2. For example, the image coding unit 100 receives a picture for every 1/120 of a second. Specifically, for example, the image coding unit 100 sequentially receives each of the pictures for every 1/120 of a second in the following order: P1 [n], P2 [n], P1 [n+1], P2 [n+1], P1 [n+2], P2 [n+2] . . . .

For example, the image coding unit 100 receives each picture P1 for every 1/60 of a second. Moreover, the image coding unit 100 receives each picture P2 for every 1/60 of a second.

It is noted the unit of pictures that the image coding unit 100 receives shall not be limited for each picture unit; instead, the unit may be for each slice, each macro block, and each group of pictures (GOP).

The image coding unit 100 encodes multiple pictures P1 forming the moving picture MV1 to generate a coded stream ST1. Moreover, the image coding unit 100 encodes multiple pictures P2 forming the moving picture MV2 to generate a coded stream ST2.

In the description below, each of the pictures P1 and P2 may be simply referred to as a picture P. Furthermore, in the description below, the coded stream ST1 and the coded stream ST2 are referred to as a first stream and a second stream, respectively.

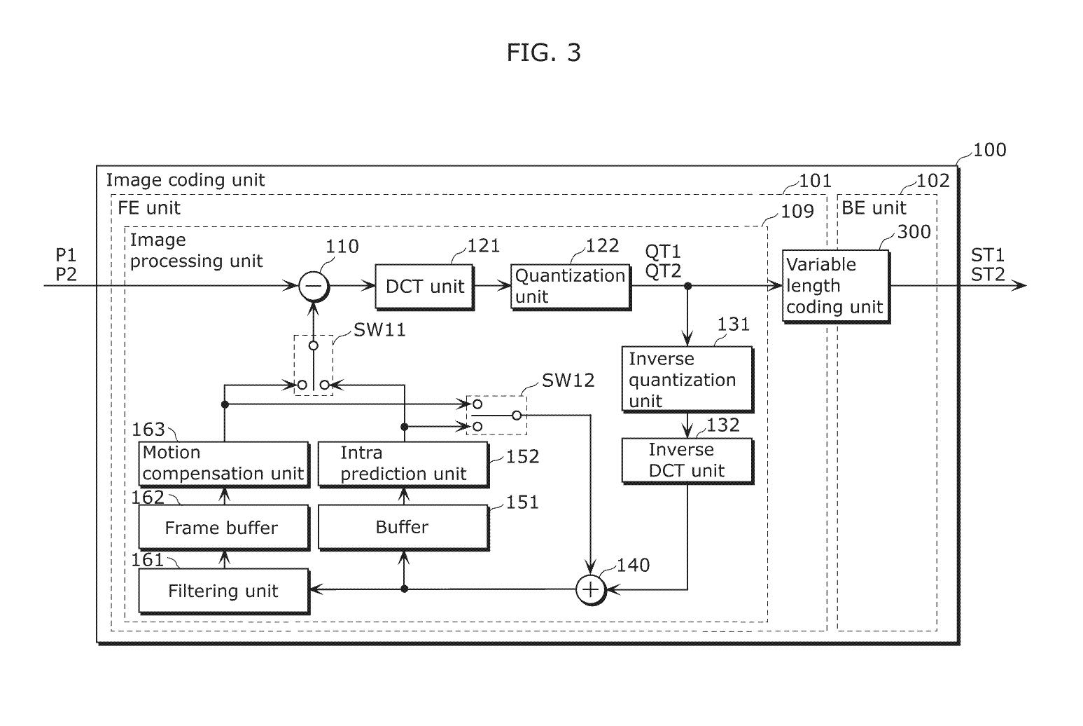

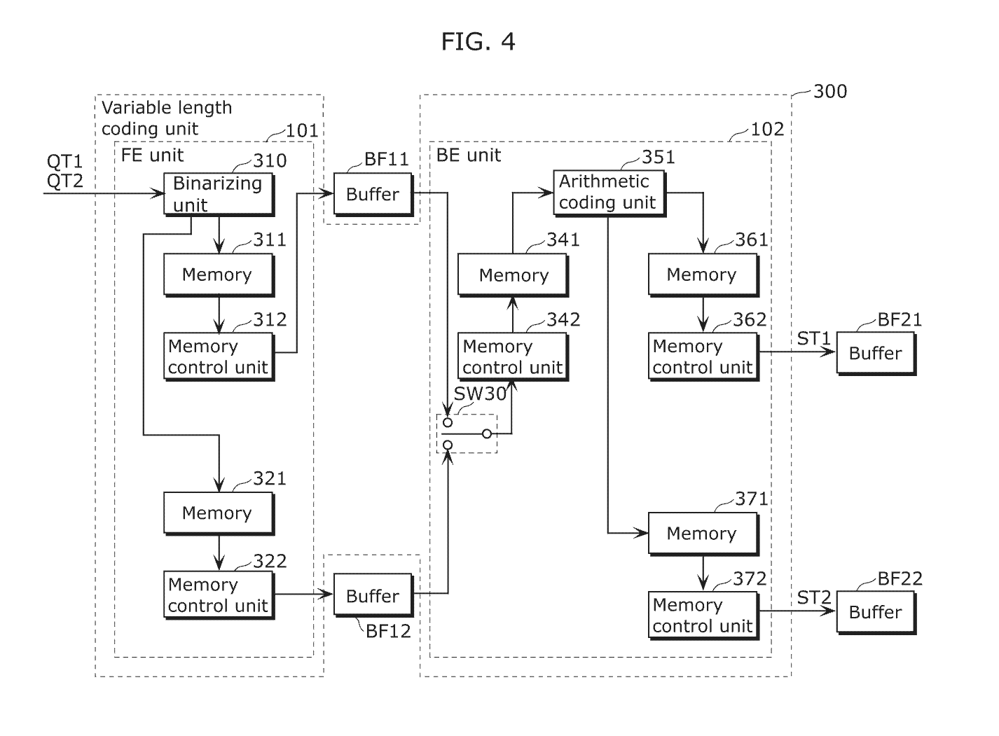

FIG. 3 is a block diagram showing a structure of the image coding unit 100 according to the embodiment.

As shown in FIG. 3, the image coding unit 100 includes an image processing unit 109, and a variable length coding unit 300.

A front end (FE) unit 101 is formed of the image processing unit 109 and part of the variable length coding unit 300. The details of the FE unit 101 shall be described later. Moreover, a back end (BE) unit 102 is formed of part of the variable length coding unit 300 other than the FE unit 101.

The image processing unit 109 operates based on the control from the control unit 210. The image processing unit 109 executes encoding based on the H.264/AVC standard. It is noted that the image processing unit 109 may utilize its configuration to execute encoding based on, for example, the MPEG-2, the MPEG-4, the H.261, and the H.263 standards.

Moreover, the control unit 210 controls the operation of the variable length coding unit 300.

The image processing unit 109 includes a subractor 110, a discrete cosine transform (DCT) unit 121, a quantization unit 122, an inverse quantization unit 131, an inverse DCT unit 132, an adder 140, an intra prediction unit 152, a filtering unit 161, a motion compensation unit 163, and switches SW11 and SW12. Each of the units is briefly described below.

The subractor 110 generates differential images based on the two kinds of images. The DCT unit 121 performs discrete cosine transform (Hereinafter referred to as DCT). The quantization unit 122 performs quantization.

The variable length coding unit 300 performs context-adaptive binary arithmetic coding (CABAC). The variable length coding unit 300 also performs context-adaptive variable length coding (CAVLC).

The inverse quantization unit 131 performs inverse quantization. The inverse DCT unit 132 performs inverse DCT. The adder 140 adds the two kinds of images. The intra prediction unit 152 performs intra prediction (intra picture prediction).

The filtering unit 161 performs deblock-filtering. The motion compensation unit 163 performs motion compensation. In response to the direction from the control unit 210, the switch SW11 transmits to the subractor 110 either one of the two kinds of images received from the outside. In response to the direction from the control unit 210, the switch SW12 transmits to the adder 140 either one of the two kinds of images received from the outside.

It is noted that a buffer 151 and a frame buffer 162 in FIG. 3 are shown in the image processing unit 109 for the sake of explanation. The buffer 151 and the frame buffer 162, however, are not actually included in the image processing unit 109. Both of the buffer 151 and the frame buffer 162 are included in each of the memories 221 and 222. It is noted that either one of or both the buffer 151 and the frame buffer 162 may be included in the image processing unit 109.

Described next is the processing executed by each of the units in the image processing unit 109. The processing of each of the units included in the image processing unit 109 is executed based on the H.264/AVC standard. Thus, the details thereof shall be omitted. Described hereinafter is a brief explanation of the processing.

The subractor 110 alternately receives the pictures P1 in the moving picture MV1 and the pictures P2 in the moving picture MV2. For example, the subractor 110 receives each of the pictures P for every 1/120 of a second. Specifically, for example, the subractor 110 sequentially receives each of the pictures for every 1/120 of a second in the following order: P1 [n], P2 [n], P1 [n+1], P2 [n+1], P1 [n+2], P2 [n+2] . . . .

In other words, the subractor 110 receives each picture P1 for every 1/60 of a second. Furthermore, the subractor 110 receives each picture P2 for every 1/60 of a second.

First, as an example, described is the processing that each of the units in the image processing unit 109 executes on each of the pictures P1 included in the moving picture MV1.

Upon receiving each of the pictures P1, the subractor 110 generates a differential image (hereinafter referred to as differential image D1) which represents the difference between the picture P1 and an after-described predictive image to be transmitted from the after-described switch SW11. Then, the subractor 110 transmits the differential image D1 to the DCT unit 121. The predictive image is either an after-described predictive image Y1A or predictive image Y1B.

For each reception of the differential image D1, the DCT unit 121 performs DCT on the received differential image D1 for each block in order to obtain a group of DCT coefficients corresponding to each block. The group of DCT coefficients includes multiple DCT coefficients. For each obtainment of the group of DCT coefficients corresponding to the differential image D1, the DCT unit 121 transmits the obtained group of DCT coefficients to the quantization unit 122.

For each reception of the group of DCT coefficients corresponding to the differential image D1, the quantization unit 122 quantizes the received group of DCT coefficients to obtain quantized data QT1. For each obtainment of the quantized data QT1 corresponding to the differential image D1, the quantization unit 122 transmits the obtained quantized data QT1 to the variable length coding unit 300 and the inverse quantization unit 131.

For each reception of the quantized data QT1, the inverse quantization unit 131 inverse-quantizes the received quantized data QT1 to obtain a group of DCT coefficients corresponding to the differential image D1. For each obtainment of the group of DCT coefficients corresponding to the differential image D1, the inverse quantization unit 131 transmits the obtained group of DCT coefficients to the inverse DCT unit 132.

For each reception of the group of DCT coefficients corresponding to the differential image D1, the inverse DCT unit 132 performs inverse DCT on the received group of DCT coefficients to obtain a differential image DB1 corresponding to the differential image D1. The differential image DB1 is part of the differential image D1. For each obtainment of the differential image DB1, the inverse DCT unit 132 transmits the obtained differential image DB1 to the adder 140.

For each reception of all of the differential images DB1 corresponding to the differential image D1, the adder 140 adds the after-described predictive image to be transmitted from the after-described switch SW12 to all of the obtained differential images DB1. Hence, the adder 140 obtains a reconstructed image T1. The predictive image is either the after-described predictive image Y1A or predictive image Y1B.

For each obtainment of the reconstructed image T1, the adder 140 transmits the obtained reconstructed image T1 to the filtering unit 161, and stores the reconstructed image T1 in the buffer 151 provided in the memory 221.

Based on the reconstructed image T1 stored in the buffer 151 provided in the memory 221, the intra prediction unit 152 performs intra-picture prediction in order to obtain a predictive image (Hereinafter referred to as predictive image Y1A). The intra-picture prediction is known processing. Thus, the details thereof shall be omitted.

For each obtainment of the predictive image Y1A, the intra prediction unit 152 transmits the obtained predictive image Y1A to the switches SW11 and SW12.

For each reception of the reconstructed image T1, the filtering unit 161 performs deblock-filtering on the received reconstructed image T1. The deblock-filtering is known processing. Thus, the details thereof shall be omitted. Then, the filtering unit 161 stores the deblock-filtered reconstructed image T1 as a reference image R1 in the frame buffer 162 provided in the memory 221.

Based on the multiple reference images R1 stored in the frame buffer 162, the motion compensation unit 163 performs motion compensation to obtain a predictive image (Hereinafter referred to as predictive image Y1B). The motion compensation is known processing. Thus, the details thereof shall be omitted. For each obtainment of the predictive image Y1B, the motion compensation unit 163 transmits the obtained predictive image Y1B to the switches SW11 and SW12.

In response to the direction from the control unit 210, the switch SW11 transmits to the subractor 110 a received one of the predictive image Y1A and the predictive image Y1B.

In response to the direction from the control unit 210, the switch SW12 transmits to the adder 140 a received one of the predictive image Y1A and the predictive image Y1B.

The above processing is performed on each of the pictures P1 included in the moving picture MV1.

Described next is processing which each of the units in the image processing unit 109 executes on each of the pictures P2 included in the moving picture MV2. It is noted that the processing on the pictures P2 of each of the units in the image processing unit 109 is similar to that on the pictures P1 of each of the units in the image processing unit 109. Thus, the details of the processing shall be omitted. Briefly described hereinafter is the processing on the pictures P2.

Upon receiving each of the pictures P2, the subractor 110 generates a differential image (hereinafter referred to as differential image D2) which represents the difference between the picture P2 and an after-described predictive image to be transmitted from the after-described switch SW11. Then, the subractor 110 transmits the differential image D2 to the DCT unit 121. The predictive image is either the after-described predictive image Y2A or predictive image Y2B

For each reception of the differential image D2, the DCT unit 121 performs DCT on the received differential image D2 for each block in order to obtain a group of DCT coefficients corresponding to each block. For each obtainment of the group of DCT coefficients corresponding to the differential image D2, the DCT unit 121 transmits the obtained group of DCT coefficients to the quantization unit 122.

For each reception of the group of DCT coefficients corresponding to the differential image D2, the quantization unit 122 quantizes the received group of DCT coefficients to obtain quantized data QT2. For each reception of the quantized data QT2 corresponding to the differential image D2, the quantization unit 122 transmits the received quantized data QT2 to the variable length coding unit 300 and the inverse quantization unit 131.

For each reception of the quantized data QT2, the inverse quantization unit 131 inverse-quantizes the received quantized data QT2 to obtain a group of DCT coefficients corresponding to the differential image D2. For each reception of the group of DCT coefficients corresponding to the differential image D2, the inverse quantization unit 131 transmits the group of DCT coefficients to the inverse DCT unit 132.

For each reception of the group of DCT coefficients corresponding to the differential image D2, the inverse DCT unit 132 performs inverse DCT on the received group of DCT coefficients to obtain a differential image DB2 corresponding to the differential image D2. The differential image DB2 is part of the differential image D2. For each obtainment of the differential image DB2, the inverse DCT unit 132 transmits the obtained differential image DB2 to the adder 140.

For each reception of all of the differential images DB2 corresponding to the differential image D2, the adder 140 adds the after-described predictive image to be transmitted from the after-described switch SW12 to the entire differential image DB2. Hence, the adder 140 obtains a reconstructed image T2. The predictive image is either the after-described predictive image Y2A or predictive image Y2B.

For each reception of the reconstructed image T2, the adder 140 transmits the obtained reconstructed image T2 to the filtering unit 161, and stores the obtained reconstructed image T2 in the buffer 151 provided in the memory 222.

Based on the reconstructed image T2 stored in the buffer 151 provided in the memory 222, the intra prediction unit 152 performs intra-picture prediction in order to obtain a predictive image (Hereinafter referred to as predictive image Y2A).

For each obtainment of the predictive image Y2A, the intra prediction unit 152 transmits the obtained predictive image Y2A to the switches SW11 and SW12.

For each reception of the reconstructed image T2, the filtering unit 161 performs deblock-filtering on the received reconstructed image T2. Then, the filtering unit 161 stores the deblock-filtered reconstructed image T2 as a reference image R2 in the frame buffer 162 provided in the memory 222.

Based on the multiple reference images R2 stored in the frame buffer 162, the motion compensation unit 163 performs motion compensation to obtain a predictive image (Hereinafter referred to as predictive image Y2B). For each obtainment of the predictive image Y2B, the motion compensation unit 163 transmits the obtained predictive image Y2B to the switches SW11 and SW12.

In response to the direction from the control unit 210, the switch SW11 transmits a received one of the predictive image Y2A and the predictive image Y2B to the subractor 110.

In response to the direction from the control unit 210, the switch SW12 transmits a received one of the predictive image Y2A and the predictive image Y2B to the adder 140.

The above processing is performed on each of the pictures P2 included in the moving picture MV2.

Through the above processing, each of the units in the image processing unit 109 performs the processing alternately on the pictures P1 and on the pictures P2. Thus, the variable length coding unit 300 alternately receives a piece of the quantized data QT1 corresponding to one of the pictures P1 and a piece of the quantized data QT2 corresponding to one of the pictures P2.

Hereinafter, the quantized data QT1 and the quantized data QT2 are referred to as first quantized data and second quantized data, respectively.

FIG. 4 is a block diagram showing a structure of the variable length coding unit 300 according to the embodiment. It is noted that FIG. 4 illustrates buffers BF11, BF12, BF21, and BF22 for the purpose of explanation. The buffers BF11 and BF21 are provided in the memory 221. The buffers BF12 and BF22 are provided in the memory 222.

It is noted that the buffers BF21 and BF22 may be provided outside the memories 221 and 222, respectively. For example, each of the buffers BF21 and BF22 may be included in the image coding apparatus 1000 and provided outside the image coding unit 100.

As shown in FIG. 4, the variable length coding unit 300 includes a binarizing unit 310, memories 311, 321, 341, 361, and 371, memory control units 312, 322, 342, 362, and 372, an arithmetic coding unit 351, and a switch SW30.

The FE unit 101 includes the image processing unit 109 in FIG. 3, the binarizing unit 310, the memories 311 and 321, and the memory control units 312 and 322.

The BE unit 102 includes the arithmetic coding unit 351, the memories 341, 361, and 371, the memory control units 342, 362, and 372, and the switch SW30.

The binarizing unit 310 binarizes quantized data. It is noted that the binarizing unit 310 also performs CAVLC.

Each of the memories 311, 321, 341, 361, and 371 is a first-in-first-out (FIFO) memory. It is noted that each of the memories 311, 321, 341, 361, and 371 does not have to be limited to the FIFO memory; instead, each of the memories may be another kind of memory (DRAM, for example).

Each of the memory control units 312, 322, 342, 362, and 372 is a direct memory access controller (DMAC). It is noted that each of the memory control units 312, 322, 342, 362, and 372 does not have to be limited to the DMAC; instead, each of the memory control units may be another kind of circuit as far as the circuit is capable of accessing the data in a memory.

The arithmetic coding unit 351 performs binary arithmetic coding in CABAC. The binary arithmetic coding in CABAC is a known technique, and thus the details thereof shall be omitted. It is noted that the arithmetic coding unit 351 also works as a context calculating unit which conforms with the H.264/AVC standard. The arithmetic coding unit 351 is formed of hardware (circuit).

Hereinafter, the binary arithmetic coding performed by the arithmetic coding unit 351 in CABAC is simply referred to as arithmetic coding.

In response to the direction from the control unit 210, the switch SW30 electrically connects the memory control unit 342 with either the buffer BF11 or the buffer BF12.

Described next is processing by each of the units in the variable length coding unit 300.

Here, when the binarizing unit 310 binarizes the quantized data QT1, the control unit 210 gives a direction to the binarizing unit 310 so that the binarizing unit 310 stores the binarized quantized data QT1 in the memory 311. When the binarizing unit 310 binarizes the quantized data QT2, the control unit 210 gives a direction to the binarizing unit 310 so that the binarizing unit 310 stores the binarized quantized data QT2 in the memory 321.

The binarizing unit 310 alternately receives a piece of the quantized data QT1 corresponding to one of the pictures P1 and a piece of the quantized data QT2 corresponding to one of the pictures P2.

For each reception of the quantized data QT1, the binarizing unit 310 binarizes the received quantized data QT1 to generate binary data BD1. For each generation of the binary data BD1, the binarizing unit 310 stores the generated binary data BD1 in the memory 311.

For each reception of the quantized data QT2, the binarizing unit 310 binarizes the received quantized data QT2 to generate binary data BD2. For each generation of the binary data BD2, the binarizing unit 310 stores the generated binary data BD2 in the memory 321.

Hereinafter, the binary data BD1 and the binary data BD2 are referred to as first binary data and second binary data, respectively.

In other words, the binarizing unit 310 alternately switches, using a time division technique, between data-to-be-binarized in each piece of the quantized data QT1 and data-to-be-binarized in each piece of the quantized data QT2. Specifically, the binarizing unit 310 switches, using the time division technique, between data-to-be-binarized in the quantized data QT1 and data-to-be-binarized in the quantized data QT2.

In other words, the binarizing unit 310 alternately binarizes, using the time division technique, each piece of the quantized data QT1 (the first quantized data) and each piece of the quantized data QT2 (the second quantized data). In other words, the binarizing unit 310 alternately binarizes, using the time division technique, the quantized data QT1 and the quantized data QT2.

Specifically, the binarizing unit 310 binarizes each piece of the quantized data QT1 and each piece of the quantized data QT2. Through the above processing, the binarizing unit 310 generates (i) pieces of the binary data BD1 each corresponding to one of the pieces of the quantized data QT1 and (ii) pieces of the binary data BD2 each corresponding to one of the pieces of the quantized data QT2. In other words, the binarizing unit 310 generates (i) pieces of the first binary data each corresponding to one of the pieces of the first quantized data and (ii) pieces of the second binary data each corresponding to one of the pieces of second quantized data.

For each storing of the most recently used binary data BD1 in the memory 311, the memory control unit 312 reads the least recently used binary data BD1 stored in the memory 311, and stores the read binary data BD1 in the buffer BF11. Here, the capacity of the buffer BF11 is large enough to hold pieces of binary data BD1 each corresponding to one or more pictures.

The processing executed by the memory control unit 312 is repeated, depending on the number of pieces of the binary data BD1 corresponding to one of the pictures P1. Hence, the buffer BF11 holds multiple pieces of the binary data BD1 corresponding to one of the pictures P1.

For each storing of the most recently used binary data BD2 in the memory 321, the memory control unit 322 reads the least recently used binary data BD2 stored in the memory 321, and stores the read binary data BD2 in the buffer BF12. Here, the capacity of the buffer BF12 is large enough to store pieces of binary data BD2 each corresponding to one or more pictures.

The processing executed by the memory control unit 322 is repeated, depending on the number of pieces of the binary data BD2 corresponding to one of the pictures P2. Hence, the buffer BF12 hold multiple pieces of the binary data BD2 corresponding to one of the pictures P2.

The above processing performed on the pictures P1 by each of the binarizing unit 310 and the memory control unit 312 is repeated to handle the amount of data for the number of the pictures P1 included in the moving picture MV1. The above processing performed on the pictures P2 by each of the binarizing unit 310 and the memory control unit 312 is repeated to handle the amount of data for the number of the pictures P2 included in the moving picture MV2.

The memory control unit 342 sequentially reads pieces of binary data corresponding to the least recently used picture from a buffer (the buffer BF11 or the buffer BF12) electrically connected by the switch SW30 with the memory control unit 342 itself.

For each time period required to store, in a buffer, each piece of the binary data corresponding to one of the pictures, for example, the switch SW30 switches between the buffer BF11 and the buffer BF12. The buffers are electrically connected with the memory control unit 342.

Suppose the switch SW30 electrically connects the buffer BF11 with the memory control unit 342. Here, the control unit 210 gives a direction to the arithmetic coding unit 351 so that the arithmetic coding unit 351 stores after-described data, to be generated by the arithmetic coding 351 itself, in the memory 361.

Here, the memory control unit 342 sequentially reads multiple pieces of the binary data BD1 corresponding to the least recently used Picture P1 stored in the buffer BF11.

Upon reading each piece of the binary data BD1, the memory control unit 342 stores the read piece of the binary data BD1 in the memory 341.

For each storing of the most recently used binary data BD1 in the memory 341, the arithmetic coding unit 351 reads the least recently used binary data BD1 stored in the memory 341. Then, upon reading each piece of the binary data BD1, the arithmetic coding unit 351 performs the binary arithmetic coding on the read piece of the binary data BD1 in order to generate coded data ED1. The generated coded data ED1 is the coded stream ST1 corresponding to a piece of the binary data BD1.

The bit length of each piece of the coded data ED1 generated by the arithmetic coding unit 351 is not constant due to the characteristics of the binary arithmetic coding.

The arithmetic coding unit 351 repeatedly executes the binary arithmetic coding, depending on the number of the pieces of the binary data BD1 corresponding to one of the pictures P1, so as to generate the coded stream ST1 corresponding to the one picture P1.

Specifically, the arithmetic coding unit 351 performs arithmetic coding on the pieces of binary data BD1 each corresponding to one of the pictures P1 so as to generate the coded stream ST1 corresponding each piece of the binary data BD1. In other words, the arithmetic coding unit 351 performs arithmetic coding on pieces of the first binary data each corresponding to one of the pictures P1 so as to generate the first stream corresponding to each piece of the first binary data.

Upon generating each piece of the coded data ED1 (the coded stream ST1), the arithmetic coding unit 351 stores the generated piece of the coded data ED1 in the memory 361.

Each time the data amount of the pieces of the coded data ED1 stored in the memory 361 becomes equal to or greater than a predetermined threshold value when the memory 361 holds the pieces of the coded data ED1, the memory control unit 362 sequentially reads the pieces of the coded data ED1 for each unit of access bits.

Here, an example of the threshold value is assumed as 7680 bits (960 bytes). The access bits indicate the amount of data to be entirely read out from a memory (the memory 361, for example). An example of the access bits is assumed as 32 bits (4 bytes).

Here, the memory control unit 362 sequentially reads pieces of the coded data ED1 for each 32 bits, and stores the sequentially-read piece of coded data ED1 in the buffer BF21.

The memory control unit 362 repeats processing as much data as the pieces of the coded data ED1 corresponding to a picture P1 has, in order to store the pieces of the coded data ED1 corresponding to the one picture P1.

Hence, the buffer BF21 holds the coded stream ST1 including the pieces of the coded data ED1 (the coded stream ST1).

The above processing performed on the pictures P1 by each of the memory control unit 342, the arithmetic coding unit 351, and the memory control unit 362 is repeated to handle the amount of data for the number of the pictures P1 included in the moving picture MV1, so that the buffer BF21 holds the coded stream ST1 corresponding to the moving picture MV1.

Next, suppose the switch SW30 electrically connects the buffer BF12 with the memory control unit 342. Here, the control unit 210 gives a direction to the arithmetic coding unit 351 so that the arithmetic coding unit 351 stores after-described data, to be generated by the arithmetic coding 351 itself, in the memory 371.

Here, the memory control unit 342 sequentially reads multiple pieces of the binary data BD2 corresponding to the least recently used picture P2 stored in the buffer BF12.

Upon reading each piece of the binary data BD2, the memory control unit 342 stores the read piece of the binary data BD2 in the memory 341.

For each storing of the most recently used binary data BD2 in the memory 341, the arithmetic coding unit 351 reads the least recently used binary data BD2 stored in the memory 341. Then, upon reading each piece of the binary data BD2, the arithmetic coding unit 351 performs the binary arithmetic coding on the read piece of the binary data BD2 in order to generate coded data ED2. The generated coded data ED2 is the coded stream ST2 corresponding to a piece of the binary data BD2.

The bit length of each piece of the coded data ED2 generated by the arithmetic coding unit 351 is not constant due to the characteristics of the binary arithmetic coding.

The arithmetic coding unit 351 repeatedly executes the binary arithmetic coding, depending on the number of the pieces of the binary data BD2 corresponding to one of the pictures P2, so as to generate the coded stream ST2 corresponding to the one picture P2.

Specifically, the arithmetic coding unit 351 performs arithmetic coding on the pieces of binary data BD2 each corresponding to one of the pictures P2 so as to generate the coded stream ST2 corresponding each piece of the binary data BD2. In other words, the arithmetic coding unit 351 performs arithmetic coding on pieces of the second binary data each corresponding to one of the pictures P2 so as to generate the second stream corresponding to each piece of the second binary data.

Upon generating each piece of the coded data ED2 (the coded stream ST2), the arithmetic coding unit 351 stores the generated piece of the coded data ED2 in the memory 371.

The memory control unit 372 performs the processing similar to that performed by the memory control unit 362.

Each time the data amount of the pieces of the coded data ED2 stored in the memory 371 becomes equal to or greater than a predetermined threshold value when the memory 371 holds the pieces of the coded data ED2, the memory control unit 372 sequentially reads the pieces of the coded data ED2 for each unit of access bits.

Then, the memory control unit 372 stores, for each access-bit unit, the sequentially read each piece of the coded data ED2 in the buffer BF22.

The memory control unit 372 repeats processing as much data as the pieces of the coded data ED2 corresponding to a picture P2 has, in order to store the pieces of the coded data ED2 corresponding to the one picture P2.

Hence, the buffer BF22 holds the coded stream ST2 including the pieces of the coded data ED2 (the coded stream ST2).

The above processing performed on the pictures P2 by each of the memory control unit 342, the arithmetic coding unit 351, and the memory control unit 372 is repeated to handle the amount of data for the number of the pictures P2 included in the moving picture MV2, so that the buffer BF22 holds the coded stream ST2 corresponding to the moving picture MV2.

In other words, the arithmetic coding unit 351 performs arithmetic coding on each of the binary data BD1 and the binary data BD2 in order to generate the coded stream ST1 corresponding to each piece of the binary data BD1 and the coded stream ST1 corresponding to each piece of the binary data BD2. In other words, the arithmetic coding unit 351 performs arithmetic coding on each of the first binary data and the second binary data in order to generate the first stream corresponding to each piece of the first binary data and the second stream corresponding to each piece of the second binary data.

Based on the above processing executed by each of the units in the variable length coding unit 300, the arithmetic coding unit 351 alternately switches, using a time division technique, between data-to-be-binarized in each piece of the binary data BD1 and data-to-be-binarized in each piece of the binary data BD2.

Specifically, the arithmetic coding unit 351 switches, using the time division technique, between the data-to-be-binarized in each piece of the binary data BD1 and the data-to-be-binarized in each piece of the binary data BD2.

In other words, the arithmetic coding 351 performs, using the time division technique, binary arithmetic coding alternately on each piece of the binary data BD1 and on each piece of the binary data BD2. In other words, the arithmetic coding 351 performs, using the time division technique, binary arithmetic coding alternately on the binary data BD1 and on the binary data BD2. The arithmetic coding 351 alternately performs, using the time division technique, arithmetic coding on the first binary data and arithmetic coding on the second binary data.

As described above, in the embodiment, the memories 361 and 371 hold the coded data ED1 and the coded data ED2 (the coded streams ST1 and ST2), respectively. Specifically, each of the coded stream ST1 and the coded stream ST2 is independently held in a separate memory.

Thus, even though arithmetic coding 351 generates pieces of coded data (the coded data ED1 and the coded data ED2) each of which has a different bit length, two kinds of coded streams having a normal length are successfully generated almost simultaneously.

In other words, for example, such a feature successfully prevents the mixture of the coded data ED2 corresponding to the pictures P2 into the coded stream ST1. The feature also successfully prevents the mixture of the coded data ED1 corresponding to the pictures P1 into the coded stream ST2.

Moreover, the effect below is provided by the memories 361 and 371 holding the coded data ED1 and the coded data ED2, respectively.

Assumed here is the case where only one memory (hereinafter referred to as memory A) is provided to hold the coded data ED1 and the coded data ED2. Here, the arithmetic coding 351 needs to use a time division technique to alternately store, in the memory A, each piece of the coded data ED1 corresponding to one of the pictures P1 and each piece of the coded data ED2 corresponding to one of the pictures P2. It is noted that the bit length is not constant for each of the coded data ED1 and the coded data ED2.

Thus, with the timing (hereinafter referred to as switching timing) when the coded data ED1 and the coded data ED2 to be held in the memory A switch with each other, more and more coded data to be stored in the memory A has a bit length smaller than the access bits and is not long enough.

The switching timing indicates when, for example, the coded data to be held in the memory A switches from the coded data ED1 to the coded data ED2. It is noted that in the case where, for example, one picture in a moving picture is processed for every 1/60 of a second and two kinds of moving pictures are processed, the switching timing comes for every 1/120 of a second. It is noted that in the case where there are two kinds of moving pictures to be processed, the processing rates for both kinds of the moving pictures are not necessarily the same with each other. Thus, the switching timing could vary for each moving picture.

Hereinafter, a bit length smaller than access bits is referred to as non-access bit length.

When the memory A holds coded data having a non-access bit length with switching timing, all of the coded data having the non-access bit length needs to be read out (hereinafter referred to as readout).

The readout involves reading out coded data having a non-access bit length and adding supplementary data to the read non-access bit length, so as to generate coded data having access bits. Here, the supplementary data has bits of access bits minus non-access bit length. Each bit of the supplementary data represents a 0.

Hereinafter, the coded data of access bits which is generated by readout is referred to as non-contiguous coded data.

Assumed here is the case where 4-bit coded data is stored in the memory A at the switching timing. The access bits are 32 bits. Here, the readout involves generating 32-bit non-contiguous coded data which is made of 4-bit coded data with 28-bit supplementary data added.

In order to generate a coded stream having a single type of continuing coded data (for example, the coded data ED1) when the non-contiguous coded data is generated, the processing below is required to delete the supplementary data (hereinafter referred to as supplementary data deleting).

It is noted that the bit length is not constant for each of the coded data ED1 and the coded data ED2 to be generated. Here, for almost each switching timing, the readout and the supplementary data deleting are executed.

In other words, in order to generate normal coded streams ST1 and ST2 with the use of the memory A, the readout and the supplementary data deleting should be executed significantly often. This would inevitably require very complex control of the software and the hardware very complex. Consequently, it would be highly difficult to control the processing for generating both of the normal coded streams ST1 and ST2, using the memory A.

Suppose the software is used to execute the readout and the supplementary data deleting as many times as necessary: This would take significantly extra time to generate the normal coded streams ST1 and ST2.

In contrast, the embodiment introduces the memories 361 and 371 holding the coded data ED1 and ED2, respectively, and the memory control units 362 and 372 controlling the memories 361 and 371, respectively.

The memory 361 and the memory control unit 362 form a transmission path for the coded stream ST1. The memory 371 and the memory control unit 372 form a transmission path for the coded stream ST2. In other words, the memories 361 and 371, and the memory control units 362 and 372 form two transmission paths each corresponding to the coded streams ST1 and ST2. This structure ensures the independence of transmission for each of the coded streams ST1 and ST2.

Thus, there is no need for significantly frequent readout and supplementary data deleting, as described above. Consequently, this feature makes it easy to control the variable length coding unit 300, as well as to simultaneously generate normal coded streams ST1 and ST2 very fast.

Moreover, the arithmetic coding unit 351 switches, using the time division technique, between the data-to-be-binarized in each piece of the binary data BD1 and the data-to-be-binarized in each piece of the binary data BD2. In other words, the arithmetic coding 351 performs, using the time division technique, binary arithmetic coding alternately on the binary data BD1 and on the binary data BD2.

Such an operation successfully allows one arithmetic coding unit 351 to execute binary arithmetic coding on the binary data BD1 and the binary data BD2. In other words, such a feature eliminates the need for providing two arithmetic coding units 351 for processing the binary data BD1 and the binary data BD2.

Consequently, the feature successfully reduces the circuit scale of the variable length coding unit 300. In other words, the feature successfully reduces the circuit scale of the image coding apparatus 1000 which includes the image coding unit 100 that includes the variable length coding unit 300. Furthermore, the feature contributes to reducing the power consumption of the image coding apparatus 1000.

Hence, the present invention successfully implements an image coding apparatus whose circuit scale is reduced and which performs arithmetic coding and generates multiple kinds of streams.

It is noted that each of the quantized data QT1 and QT2 is generated from a different moving picture (the moving pictures MV1 and MV2); however, the quantized data QT1 and QT2 shall not be limited to a different moving picture. Each of the quantized data QT1 and QT2 may be obtained from the same moving picture.

Assumed here is the case where, for example, the quantized data QT1 is obtained by each of the units in the image processing unit 109 executing High-Profile-based processing on the moving picture MV1. Furthermore assumed is the case where the quantized data QT2 is obtained by each of the units in the image processing unit 109 executing Baseline-Profile-based processing on the moving picture MV2. In other words, the quantized data QT2 here does not need to be arithmetic-coded.

Here, the binarizing unit 310 performs CAVLC on the quantized data QT2 to generate the coded stream ST2. The generated coded stream ST2 is stored in the memory 321. Then, the memory control unit 322 stores the coded stream ST2 in the buffer BF12. Hence, the coded stream ST2 is stored in the buffer BF12.

It is noted that the binarizing unit 310 performs, on the quantized data QT1, processing similar to the above-described processing.

Here, the coded streams ST1 and ST2 are generated out of the same moving picture. In other words, the embodiment makes it possible to simultaneously generate the coded streams ST1 and ST2 very fast out of the same moving picture.

Moreover, the quantized data QT2 here does not need to be arithmetic-coded. Thus, the embodiment makes it possible to simultaneously process, using a time division technique, both kinds of data: The data that does not have to be arithmetic-coded and the data that has to be arithmetic-coded.

### Modification 1 of Embodiment

Modification 1 of the embodiment describes an image coding apparatus including a variable length coding unit whose structure differs from that in the embodiment.

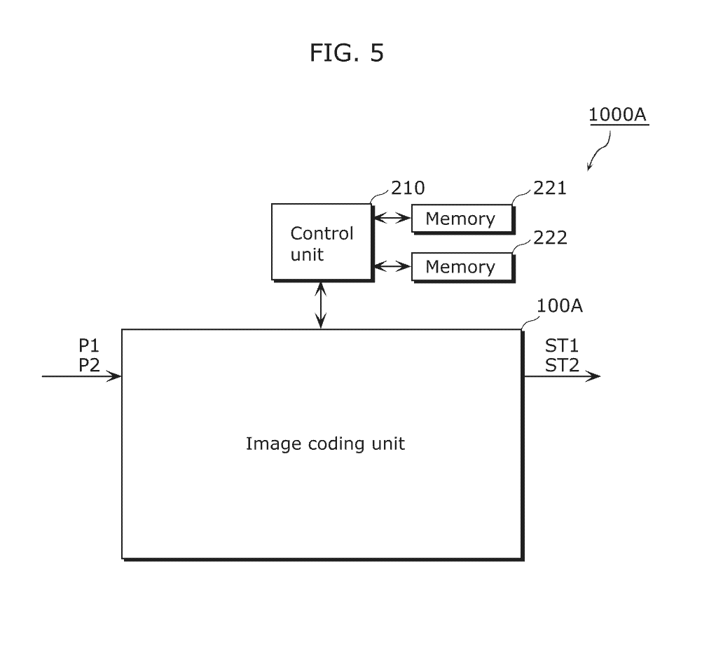

FIG. 5 is a block diagram showing a structure of an image coding apparatus 1000A according to Modification 1 of the embodiment.

A comparison shows that the image coding apparatus 1000A in FIG. 5 differs from the image coding apparatus 1000 in FIG. 1 in that the image coding apparatus 1000A includes an image coding unit 100A instead of the image coding unit 100. The other structure is similar to that of the image coding apparatus 1000. Thus, the details thereof shall be omitted.

It is noted that the control unit 210 controls the operation of the image coding unit 100A.

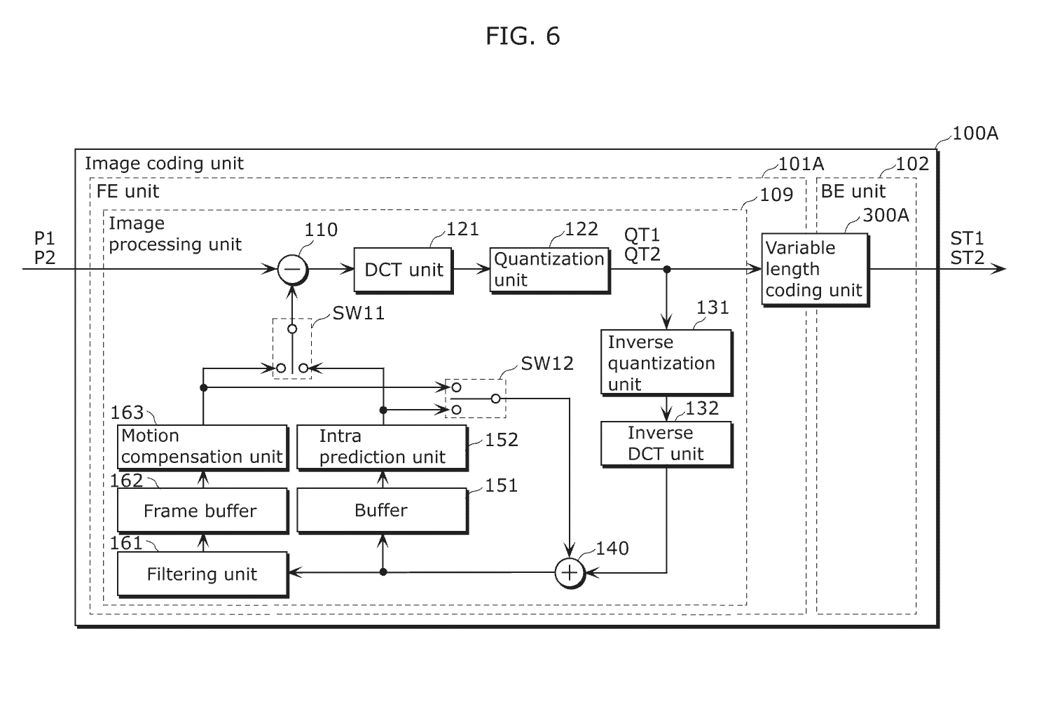

FIG. 6 is a block diagram showing a structure of the image coding unit 100A according to Modification 1 of the embodiment.

According to a comparison, the image coding unit 100A in FIG. 6 differs from the image coding unit 100 in FIG. 3 in that the image coding unit 100A includes a variable length coding unit 300A instead of the variable length coding unit 300. The functions of the other units in and the other structure of the image coding unit 100A are similar to those of the image coding unit 100. Thus, the details thereof shall be omitted.

An FE unit 101A is formed of the image processing unit 109 and part of the variable length coding unit 300A. Moreover, the BE unit 102 is formed of the part of the variable length coding unit 300A other than the FE unit 101A.

The control unit 210 controls the operation of the variable length coding unit 300A.

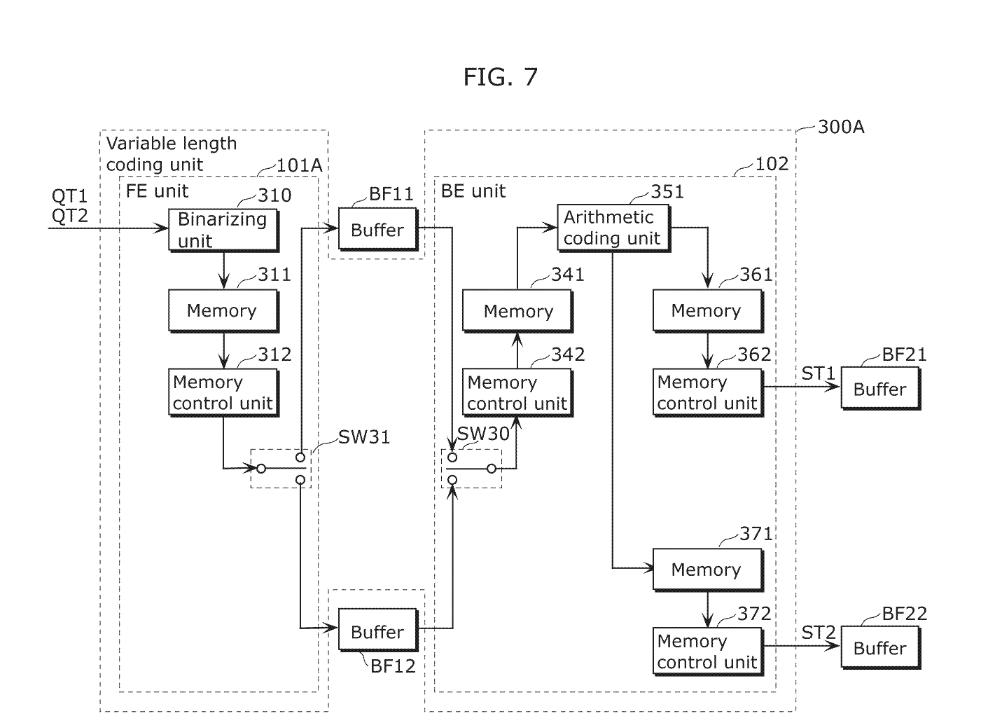

FIG. 7 is a block diagram showing a structure of the variable length coding unit 300A according to Modification 1 of the embodiment. It is noted that FIG. 7 illustrates the buffers BF11, BF12, BF21, and BF 22 for the purpose of explanation.

According to a comparison, the variable length coding unit 300A in FIG. 7 differs from the variable length coding unit 300 in FIG. 4 in that the variable length coding unit 300A further includes a switch SW31, but does not include either memory 321 or memory control unit 322. The functions of the other units in and the other structure of the variable length coding unit 300A are similar to those of the variable length coding unit 300. Thus, the details thereof shall be omitted.

The FE unit 101A includes the image processing unit 109 in FIG. 6, the binarizing unit 310, the memory 311, the memory control unit 312, and the switch SW31.

The BE unit 102 includes the arithmetic coding unit 351, the memories 341, 361, and 371, the memory control units 342, 362, and 372, and the switch SW30. In other words, the BE unit 102 in FIG. 7 and the BE unit 102 in FIG. 4 are the same in structure.

In response to the direction from the control unit 210, the switch SW31 electrically connects the memory control unit 312 with either the buffer BF11 or the buffer BF12.

Described next is processing by each of the units in the variable length coding unit 300A.

The processing by each of the units in the variable length coding unit 300A is similar to that by each of the units in the variable length coding unit 300 described in the embodiment. Thus, the details thereof shall be omitted. Mainly described below is processing different from the processing in the embodiment.

The binarizing unit 310 alternately receives pieces of the quantized data QT1 each corresponding to one of the pictures P1 and pieces of the quantized data QT2 each corresponding to one of the pictures P2.

For each reception of the quantized data QT1, the binarizing unit 310 binarizes the received quantized data QT1 to generate binary data BD1. For each generation of the binary data BD1, the binarizing unit 310 stores the generated binary data BD1 in the memory 311.

For each reception of the quantized data QT2, the binarizing unit 310 binarizes the received quantized data QT2 to generate binary data BD2. For each generation of the binary data BD1, the binarizing unit 310 stores the generated binary data BD2 in memory 311.

In other words, the binarizing unit 310 alternately switches, using a time division technique, between data-to-be-binarized in each piece of the quantized data QT1 and data-to-be-binarized in each piece of the quantized data QT2. Specifically, the binarizing unit 310 switches, using the time division technique, between data-to-be-binarized in the quantized data QT1 and data-to-be-binarized in the quantized data QT2.

In other words, the binarizing unit 310 alternately binarizes, using the time division technique, each piece of the quantized data QT1 and each piece of the quantized data QT2. In other words, the binarizing unit 310 alternately binarizes, using the time division technique, the quantized data QT1 and the quantized data QT2.

Based on a buffer (either the buffer BF11 or the buffer BF12) which is electrically connected with the memory control unit 312 itself by the operation of the switch SW31, the memory control unit 312 changes the storing destination of the data to be read from the memory 311. The storing destination is changed based on the direction from the control unit 210.

For each time period required to process each piece of the binary data corresponding to one of the pictures, for example, the switch SW31 switches between the buffer BF11 and the buffer BF12. The buffers are electrically connected with the memory control unit 312.

Here, suppose the switch SW31 electrically connects the memory control unit 312 with the buffer BF11. Here, the processing by the binarizing unit 310 causes the memory 311 to hold the binary data BD1. Furthermore, the control unit 210 gives a direction to the memory control unit 312 so that the memory control unit 312 stores, in the buffer BF11, the binary data BD1 held in the memory 311.

Moreover, for each storing of the most recently used binary data BD1 in the memory 311, the memory control unit 312 reads the least recently used binary data BD1 stored in the memory 311, and stores the read binary data BD1 in the buffer BF11.

The processing executed by the memory control unit 312 is repeated, depending on the number of pieces of the binary data BD1 corresponding to one of the pictures P1. Hence, the buffer BF11 holds multiple pieces of the binary data BD1 corresponding to one of the pictures P1.

Here, suppose the switch SW31 electrically connects the memory control unit 312 with the buffer BF12. Here, the processing by the binarizing unit 310 causes the memory 311 to hold the binary data BD2. Furthermore, the control unit 210 gives a direction to the memory control unit 312 so that the memory control unit 312 stores, in the buffer BF12, the binary data BD2 held in the memory 311.

Moreover, for each storing of the most recently used binary data BD2 in the memory 311, the memory control unit 312 reads the least recently used binary data BD2 stored in the memory 311, and stores the read binary data BD2 in the buffer BF12.

The processing executed by the memory control unit 312 is repeated, depending on the number of pieces of the binary data BD2 corresponding to one of the pictures P2. Hence, the buffer BF12 holds multiple pieces of the binary data BD2 corresponding to one of the pictures P2.

The above processing performed on the pictures P1 by each of the binarizing unit 310 and the memory control unit 312 is repeated to handle the amount of data for the number of the pictures P1 included in the moving picture MV1. The above processing performed on the pictures P2 by each of the binarizing unit 310 and the memory control unit 312 is repeated to handle the amount of data for the number of the pictures P2 included in the moving picture MV2.

It is noted that the processing performed by each of the memory control unit 342, the arithmetic coding 351, and the memory control unit 372 is similar to that described in the embodiment. Thus, the details thereof shall be omitted. In other words, the processing executed by each unit in the BE unit 102 is similar to that described in the embodiment.

As described above, Modification 1 of the embodiment provides a similar effect as the embodiment provides. In other words, Modification 1 makes it possible to almost simultaneously generate two kinds of normal and coded streams, as well as makes it easy to control the variable length coding unit 300A.

It is noted that compared with the variable length coding unit 300, the variable length coding unit 300A further includes the switch SW3, but does not include either the memory 321 or the memory control unit 322. The circuit for the switch SW31 is much smaller than that for the memory 321 or for the memory control unit 322.

Thus, Modification 1 of the embodiment can further reduce the circuit scale of the variable length coding unit 300A than that of the variable length coding unit 300. In other words, the feature successfully reduces the circuit scale of the image coding apparatus 1000A which includes the image coding unit 100A that includes the variable length coding unit 300A.

Moreover, the variable length coding unit 300A according to Modification 1 of the embodiment includes two memories each holding one of the two coded data ED1 and ED2. The coded data ED1 and ED2 are generated by the arithmetic coding unit 351 and each having a different bit length. In other words, the variable length coding unit 300A has the two memory control units for controlling the two memories provided only to the part where the readout and the supplementary data deleting are executed often when one memory is used.

This structure makes it possible to reduce the circuit scale of the image coding apparatus 1000A which includes the image coding unit 100A that includes the variable length coding unit 300A, as well as to almost simultaneously generate two kinds of normal and coded streams.

Hence, the present invention successfully implements an image coding apparatus whose circuit scale is reduced and which performs arithmetic coding and generates multiple kinds of streams.

### Modification 2 of Embodiment

Modification 2 of the embodiment describes an image coding apparatus including a variable length coding unit whose structure differs from that in the embodiment.

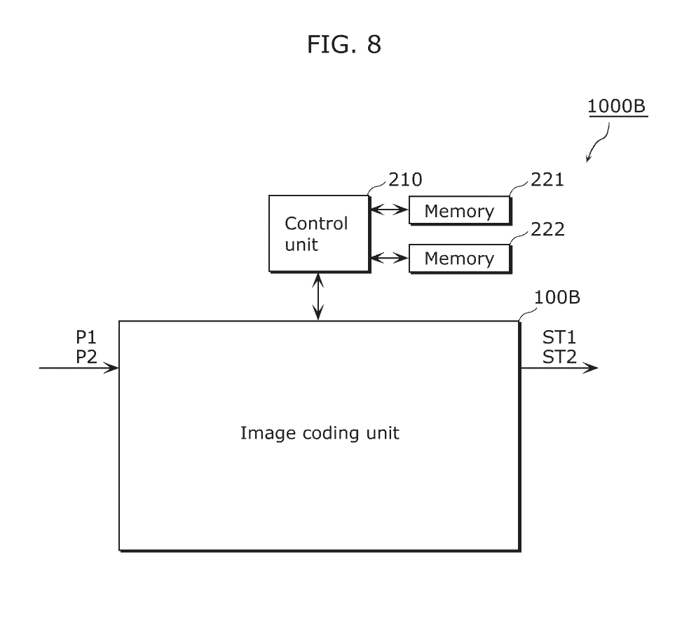

FIG. 8 is a block diagram showing a structure of an image coding apparatus 1000B according to Modification 2 of the embodiment.

A comparison shows that the image coding apparatus 1000B in FIG. 8 differs from the image coding apparatus 1000 in FIG. 1 in that the image coding apparatus 1000B includes an image coding unit 100B instead of the image coding unit 100. The other structure is similar to that of the image coding apparatus 1000. Thus, the details thereof shall be omitted.

It is noted that the control unit 210 controls the operation of the image coding unit 100B.

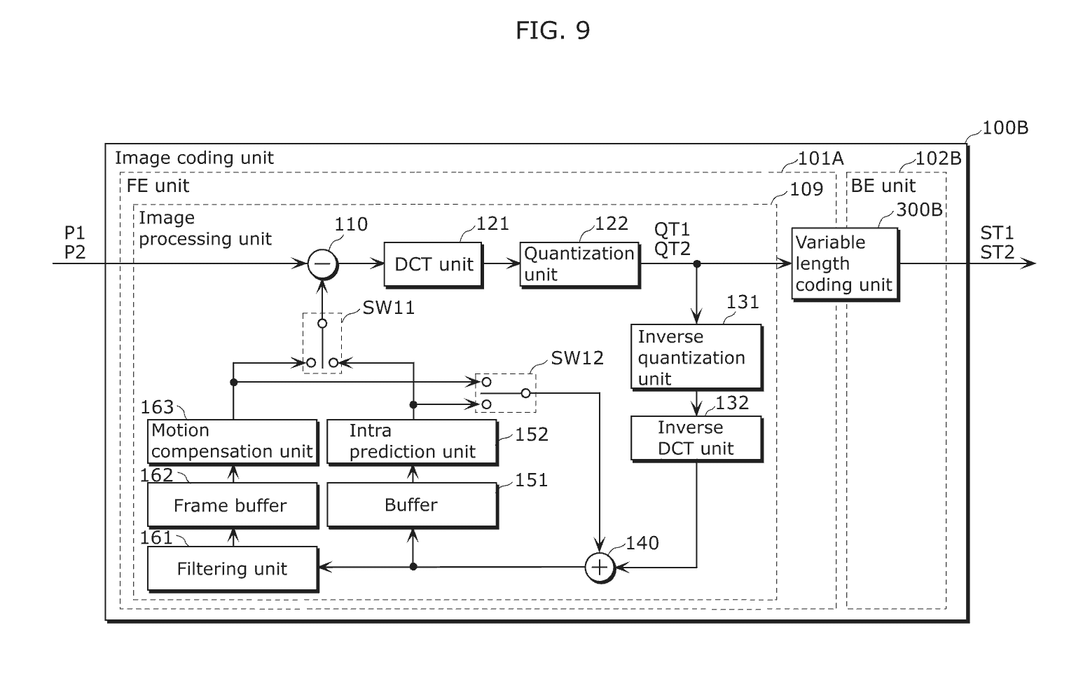

FIG. 9 is a block diagram showing a structure of the image coding unit 100B according to Modification 2 of the embodiment.

A comparison between the image coding unit 100B in FIG. 9 and the image coding unit 100 in FIG. 3 shows that the image coding unit 100B includes a variable length coding unit 300B instead of the variable length coding unit 300. The functions of the other units in and the other structure of the image coding unit 100B are similar to those of the image coding unit 100. Thus, the details thereof shall be omitted.

The FE unit 101A is formed of the image processing unit 109 and part of the variable length coding unit 300B. Moreover, a BE unit 102B is formed of the part of the variable length coding unit 300B other than the FE unit 101A.

The control unit 210 controls the operation of the variable length coding unit 300B.

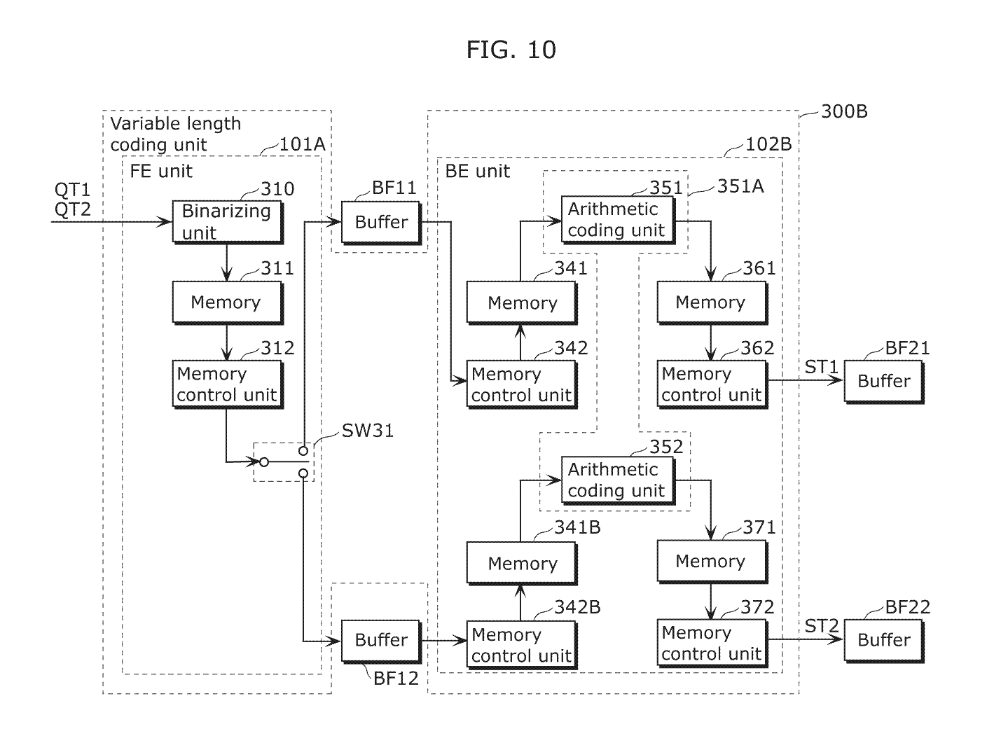

FIG. 10 is a block diagram showing a structure of the variable length coding unit 300B according to Modification 2 of the embodiment. It is noted that FIG. 10 illustrates the buffers BF11, BF12, BF21, and BF 22 for the purpose of explanation.

A comparison shows that the variable length coding unit 300B in FIG. 10 differs from the variable length coding unit 300A in FIG. 7 in that the variable length coding unit 300B further includes an arithmetic coding unit 352, a memory 341B, and a memory control unit 342B, but does not include the switch SW30. The functions of the other units in and the other structure of the variable length coding unit 300B are similar to those of the variable length coding unit 300A. Thus, the details thereof shall be omitted.

The FE unit 101A includes the image processing unit 109 in FIG. 9, the binarizing unit 310, the memory 311, the memory control unit 312, and the switch SW31. In other words, the FE unit 101A in FIG. 10 and the FE unit 101A in FIG. 7 are the same in structure.

The BE unit 102B includes the arithmetic coding unit 351 and 352, the memories 341, 341B, 361, and 371, and the memory control units 342, 342B, 362, and 372.

The arithmetic coding unit 352 and the arithmetic coding unit are the same in function. It is noted that the arithmetic coding units 351 and 352 form an arithmetic coding unit 351A. In other words, the arithmetic coding unit 351A includes the arithmetic coding unit 351 working as a first arithmetic coding unit and the arithmetic coding unit 352 working as a second arithmetic coding unit.

The memory control unit 342 is electrically connected with the buffer BF11. The memory control unit 342B is electrically connected with the buffer BF12.

Described next is processing by each of the units in the variable length coding unit 300B.

The processing by each of the units in the variable length coding unit 300B is similar to that by each of the units in the variable length coding unit 300A described in Modification 1 of the embodiment. Thus, the details thereof shall be omitted. Mainly described below is different processing from the processing in Modification 1 of the embodiment.

The processing of each of the binarizing unit 310, the memory control unit 312, and the switch SW31 all included in the variable length coding unit 300B is similar to the processing described in Modification 1 of the embodiment. Thus, the details thereof shall be omitted. Hence, the buffer BF11 holds multiple pieces of binary data BD1 corresponding to one of the pictures P1. Moreover, the buffer BF12 holds multiple pieces of binary data BD2 corresponding to one of the pictures P2.

Similar to the operation in the embodiment, the memory control unit 342 sequentially reads multiple pieces of the binary data BD1 corresponding to the least recently used picture P1 stored in the buffer BF11

Similar to the operation in the embodiment, upon reading each piece of the binary data BD1, the memory control unit 342 stores the read piece of the binary data BD1 in the memory 341.

Similar to the operation in the embodiment, for each storing of the most recently used binary data BD2 in the memory 341, the arithmetic coding unit 351 reads the least recently used binary data BD1 stored in the memory 341. Then, upon reading each piece of the binary data BD1, the arithmetic coding unit 351 performs the binary arithmetic coding on the read piece of the binary data BD1 in order to generate coded data ED1.

The arithmetic coding unit 351 repeatedly executes the binary arithmetic coding, depending on the number of the pieces of the binary data BD1 corresponding to one of the pictures P1, so as to generate the coded stream ST1 corresponding to the one picture P1.

Upon generating each piece of the coded data ED1, the arithmetic coding unit 351 stores the generated piece of the coded data ED1 in the memory 361.

Similar to the operation in the embodiment, each time the data amount of the pieces of the coded data ED1 stored in the memory 361 becomes equal to or greater than a predetermined threshold value when the memory 361 holds the pieces of the coded data ED1, the memory control unit 362 sequentially reads the pieces of the coded data ED1 for each unit of access bits.

Then, the memory control unit 362 stores, for each access-bit unit, the sequentially read each piece of the coded data ED1 in the buffer BF21.

The memory control unit 362 repeats processing as much data as the pieces of the coded data ED1 corresponding to one of the pictures P1 has, in order to store the pieces of the coded data ED1 corresponding to the one picture P1. Hence, the buffer BF21 holds the coded stream ST1 including the pieces of the coded data ED1 (the coded stream ST1).

The above processing performed on the pictures P1 by each of the memory control unit 342, the arithmetic coding unit 351, and the memory control unit 362 is repeated to handle the amount of data for the number of the pictures P1 included in the moving picture MV1, so that the buffer BF21 holds the coded stream ST1 corresponding to the moving picture MV1.

Similar to the memory control unit 342 in the embodiment, the memory control unit 342B sequentially reads multiple pieces of the binary data BD2 corresponding to the least recently used picture P2 stored in the buffer BF12.

Similar to the memory control unit 342 in the embodiment, upon reading each piece of the binary data BD2, the memory control unit 342B stores the read piece of the binary data BD2 in the memory 341B.

Similar to the arithmetic coding unit 351 in the embodiment, for each storing of the most recently used binary data BD2 in the memory 341B, the arithmetic coding unit 352 reads the least recently used binary data BD2 stored in the memory 341B. Then, upon reading each piece of the binary data BD2, the arithmetic coding unit 352 performs the binary arithmetic coding on the read piece of the binary data BD2 in order to generate coded data ED2.

The arithmetic coding unit 352 repeatedly executes the binary arithmetic coding, depending on the number of the pieces of the binary data BD2 corresponding to one of the pictures P1, so as to generate the coded stream ST2 corresponding to the one picture P2.

Similar to the arithmetic coding unit 351 in the embodiment, upon generating each piece of the coded data ED2, the arithmetic coding unit 352 stores the generated piece of the coded data ED2 in the memory 371.

Similar to the operation in the embodiment, each time the data amount of the pieces of the coded data ED2 stored in the memory 371 becomes equal to or greater than a predetermined threshold value when the memory 371 holds the pieces of the coded data ED2, the memory control unit 372 sequentially reads the pieces of the coded data ED2 for each unit of access bits.

Then, the memory control unit 372 stores, for each access-bit unit, the sequentially read each piece of the coded data ED2 in the buffer BF22.

The memory control unit 372 repeats processing as much data as the pieces of the coded data ED2 corresponding to one of the pictures P2 has, in order to store the pieces of the coded data ED2 corresponding to the one picture P2. Hence, the buffer BF22 holds the coded stream ST2 including the pieces of the coded data ED2 (the coded stream ST2).

The above processing performed on the pictures P2 by each of the memory control unit 342B, the arithmetic coding unit 352, and the memory control unit 372 is repeated to handle the amount of data for the number of the pictures P2 included in the moving picture MV2, so that the buffer BF22 holds the coded stream ST2 corresponding to the moving picture MV2.

As described above, Modification 2 of the embodiment provides a similar effect as Modification 1 of the embodiment provides. In other words, Modification 2 makes it possible to almost simultaneously generate two kinds of normal and coded streams, as well as makes it easy to control the variable length coding unit 300B.

It is noted that compared with the variable length coding unit 300A in FIG. 7, the variable length coding unit 300B in FIG. 7 further includes the arithmetic coding unit 352, the memory 341B, and the memory control unit 342B. Thus, the circuit scale of the variable length coding unit 300B is slightly larger than that of the variable length coding unit 300A.

The variable length coding unit 300B, however, has no switch SW30. Thus, in contrast to Modification 1 of the embodiment, the variable length coding unit 300B eliminates the need for the processing by the control unit 210 for the switch SW30, which contributes to reducing the load on the control unit 210.

Hence, in Modification 2 of the embodiment, the present invention successfully implements an image coding apparatus whose circuit scale is reduced and which performs arithmetic coding and generates multiple kinds of streams.

### Modification 3 of Embodiment

Modification 3 of the embodiment describes an image coding apparatus including a variable length coding unit whose structure differs from that in the embodiment.

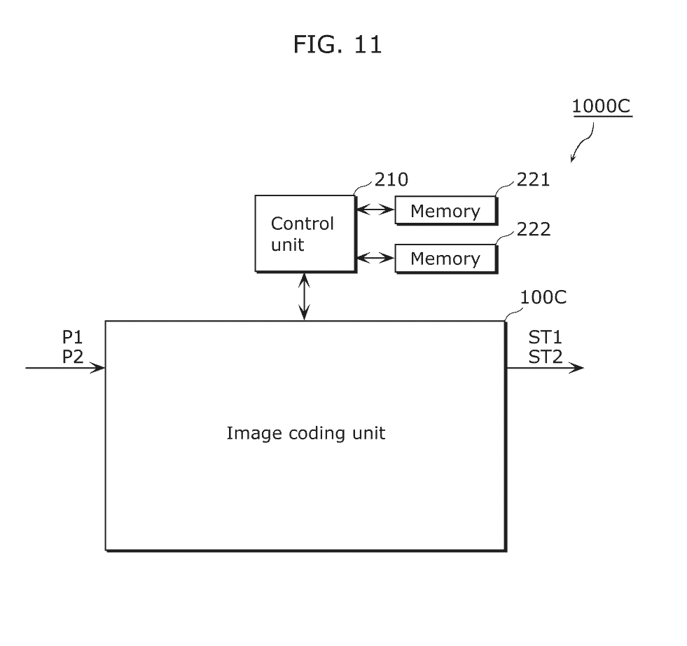

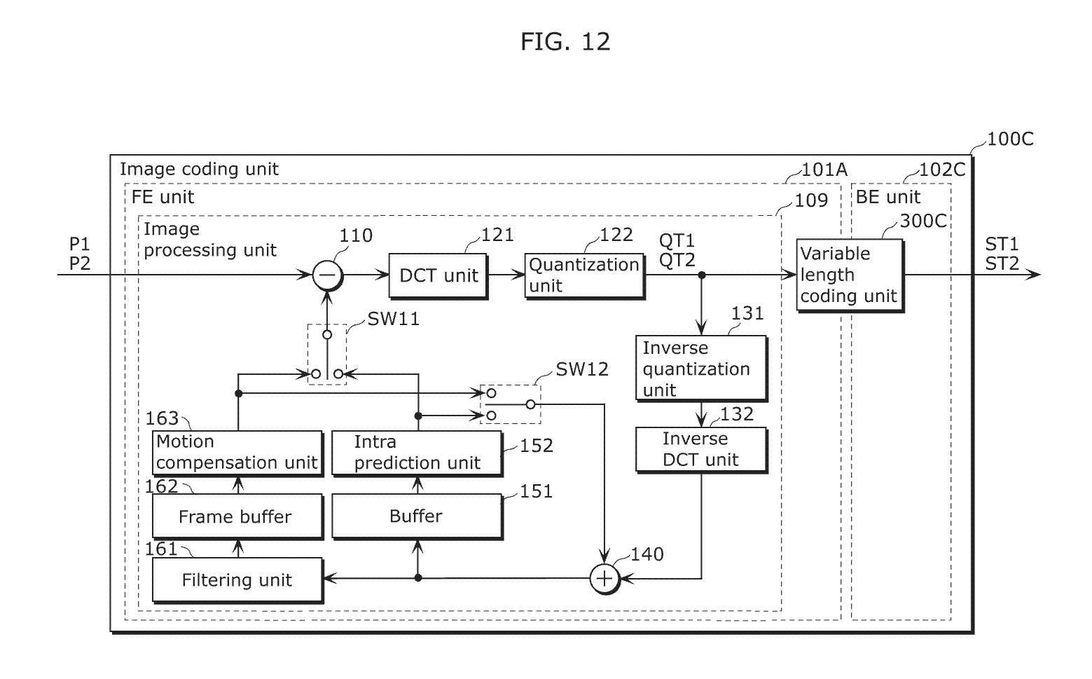

FIG. 11 is a block diagram showing a structure of an image coding apparatus 1000C according to Modification 3 of the embodiment.

A comparison shows that the image coding apparatus 1000C in FIG. 11 differs from the image coding apparatus 1000 in FIG. 1 in that the image coding apparatus 1000C includes an image coding unit 100C instead of the image coding unit 100. The other structure is similar to that of the image coding apparatus 1000. Thus, the details thereof shall be omitted.

It is noted that the control unit 210 controls the operation of the image coding unit 100C.

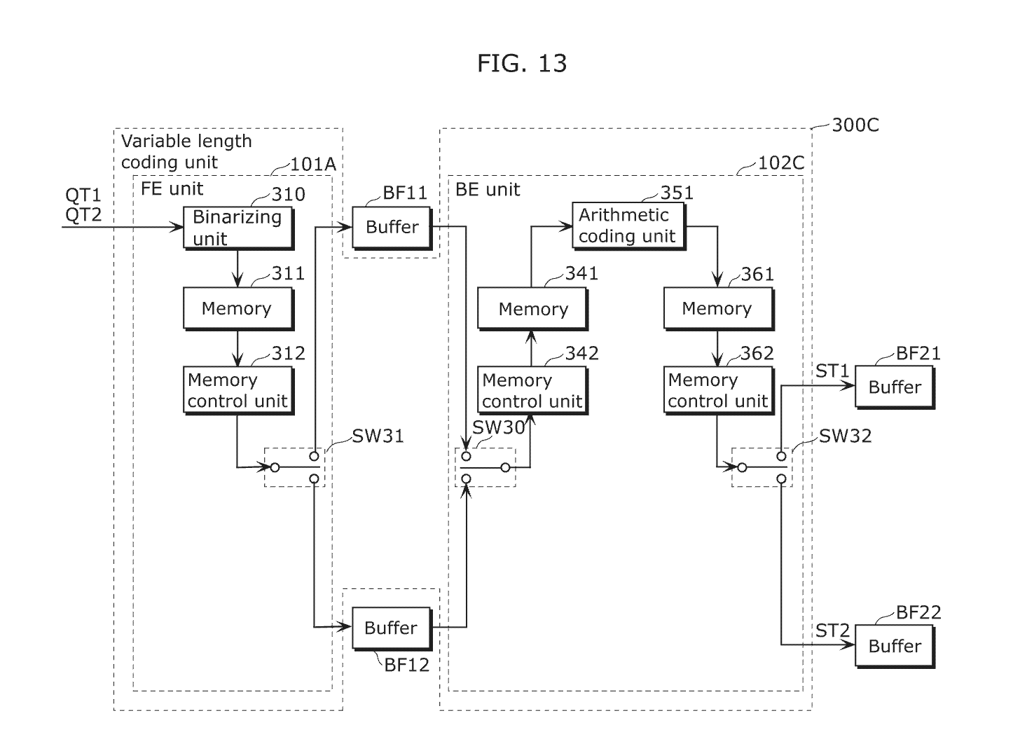

FIG. 12 is a block diagram showing a structure of an image coding unit 100C according to Modification 3 of the embodiment.

A comparison shows that the image coding unit 100C in FIG. 12 differs from the image coding unit 100 in FIG. 3 in that the image coding unit 100C includes a variable length coding unit 300C instead of the variable length coding unit 300. The functions of the other units in and the other structure of the image coding unit 100C are similar to those of the image coding unit 100. Thus, the details thereof shall be omitted.

The FE unit 101A is formed of the image processing unit 109 and part of the variable length coding unit 300C. Moreover, a BE unit 102C is formed of the part of the variable length coding unit 300C other than the FE unit 101A.

The control unit 210 controls the operation of the variable length coding unit 300C.

FIG. 13 is a block diagram showing a structure of the variable length coding unit 300C according to Modification 3 of the embodiment. It is noted that FIG. 13 illustrates the buffers BF11, BF12, BF21, and BF22 for the purpose of explanation.

A comparison shows that the variable length coding unit 300C in FIG. 13 differs from the variable length coding unit 300A in FIG. 7 in that the variable length coding unit 300C further includes a switch SW32 but does not include either memory 371 or the memory control unit 372. The functions of the other units in and the other structure of the variable length coding unit 300C are similar to those of the variable length coding unit 300A. Thus, the details thereof shall be omitted.

The FE unit 101A includes the image processing unit 109 in FIG. 12, the binarizing unit 310, the memory 311, the memory control unit 312, and the switch SW31. In other words, the FE unit 101A in FIG. 13 and the FE unit 101A in FIG. 7 are the same in structure.

A BE unit 102C includes the arithmetic coding unit 351, the memories 341 and 361, the memory control units 342 and 362, and the switches SW30 and SW32.

In response to the direction from the control unit 210, the switch SW32 electrically connects the memory control unit 362 with either the buffer BF21 or the buffer BF22.

Described next is processing by each of the units in the variable length coding unit 300C.

The processing by each of the units in the variable length coding unit 300C is similar to that by each of the units in the variable length coding unit 300A described in Modification 1 of the embodiment. Thus, the details thereof shall be omitted. Mainly described below is different processing from the processing in Modification 1 of the embodiment.

The processing of each of the binarizing unit 310, the memory control unit 312, and the switch SW31 all included in the variable length coding unit 300C is similar to the processing described in Modification 1 of the embodiment. Thus, the details thereof shall be omitted. Hence, the buffer BF11 holds multiple pieces of binary data BD1 corresponding to one of the pictures P1. Moreover, the buffer BF12 holds multiple pieces of binary data BD2 corresponding to one of the pictures P2.

The processing of each of the switch SW30 and the memory control unit 342 both included in the variable length coding unit 300C is similar to that described in the embodiment. Thus, the details thereof shall be omitted.

This operation allows the memory 341 to hold the binary data BD1 when the switch SW30 electrically connects the buffer BF11 with the memory control unit 342.

Furthermore, this operation allows the memory 341 to hold the binary data BD2 when the switch SW30 electrically connects the buffer BF12 with the memory control unit 342.

In response to the direction from the control unit 210, the switch SW32 electrically connects the memory control unit 362 with the buffer BF21 when the arithmetic coding unit 351 is processing the binary data BD1.

In response to the direction from the control unit 210, the switch SW32 electrically connects the memory control unit 362 with the buffer BF22 when the arithmetic coding unit 351 is processing the binary data BD2.

Here, suppose the switch SW30 electrically connects the memory control unit 342 with the buffer BF11.

For each storing of the most recently used binary data BD1 in the memory 341, the arithmetic coding unit 351 reads the least recently used binary data BD1 stored in the memory 341. Then, upon reading each piece of the binary data BD1, the arithmetic coding unit 351 performs the binary arithmetic coding on the read piece of the binary data BD1 in order to generate coded data ED1.

The bit length of each piece of the coded data ED1 generated by the arithmetic coding unit 351 is not constant due to the characteristics of the binary arithmetic coding.

The arithmetic coding unit 351 repeatedly executes the binary arithmetic coding, depending on the number of the pieces of the binary data BD1 corresponding to one of the pictures P1, so as to generate the coded stream ST1 corresponding to the one picture P1.

Upon generating each piece of the coded data ED1 (the coded stream ST1), the arithmetic coding unit 351 stores the generated piece of the coded data ED1 in the memory 361.

It is noted that the switch SW32 electrically connects the memory control unit 362 with the buffer BF21 when the arithmetic coding unit 351 is processing the binary data BD1.

Similar to the operation in the embodiment, each time the data amount of the pieces of the coded data ED1 stored in the memory 361 becomes equal to or greater than a predetermined threshold value when the memory 361 holds the pieces of the coded data ED1, the memory control unit 362 sequentially reads the pieces of the coded data ED1 for each unit of access bits.

Then, the memory control unit 362 stores, for each access-bit unit, the sequentially read each piece of the coded data ED1 in the buffer BF21.

The memory control unit 362 repeats processing as much data as the pieces of the coded data ED1 corresponding to one of the pictures P1 has, in order to store the pieces of the coded data ED1 corresponding to the one picture P1.

Hence, the buffer BF21 holds the coded stream ST1 including the pieces of the coded data ED1 (the coded stream ST1).

The above processing performed on the pictures P1 by each of the memory control unit 342, the arithmetic coding unit 351, and the memory control unit 362 is repeated to handle the amount of data for the number of the pictures P1 included in the moving picture MV1, so that the buffer BF21 holds the coded stream ST1 corresponding to the moving picture MV1.

Here, suppose the switch SW30 electrically connects the buffer BF12 with the memory control unit 342.

For each storing of the most recently used binary data BD2 in the memory 341, the arithmetic coding unit 351 reads the least recent binary data BD2 stored in the memory 341. Then, upon reading each piece of the binary data BD2, the arithmetic coding unit 351 performs the binary arithmetic coding on the read piece of the binary data BD2 in order to generate coded data ED2.

The bit length of each piece of the coded data ED2 generated by the arithmetic coding unit 351 is not constant due to the characteristics of the binary arithmetic coding.

The arithmetic coding unit 351 repeatedly executes the binary arithmetic coding, depending on the number of the pieces of the binary data BD2 corresponding to one of the pictures P2, so as to generate the coded stream ST2 corresponding to the one picture P2.

Upon generating each piece of the coded data ED2 (the coded stream ST2), the arithmetic coding unit 351 stores the generated piece of the coded data ED2 in the memory 361.

It is noted that the switch SW32 electrically connects the memory control unit 362 with the buffer BF22 when the arithmetic coding unit 351 is processing the binary data BD2.

Similar to the operation in the embodiment, each time the data amount of the pieces of the coded data ED2 stored in the memory 361 becomes equal to or greater than a predetermined threshold value when the memory 361 holds the pieces of the coded data ED2, the memory control unit 362 sequentially reads the pieces of the coded data ED2 for each unit of access bits.

Then, the memory control unit 362 stores, for each access-bit unit, the sequentially read each piece of the coded data ED2 in the buffer BF22.

The memory control unit 362 repeats processing as much data as the pieces of the coded data ED2 corresponding to one of the pictures P2 has, in order to store the pieces of coded data ED2 corresponding to the one picture P2.

Hence, the buffer BF22 holds the coded stream ST2 including the pieces of the coded data ED2 (the coded stream ST2).

The above processing performed on the pictures P2 by each of the memory control unit 342, the arithmetic coding unit 351, and the memory control unit 362 is repeated to handle the amount of data for the number of the pictures P2 included in the moving picture MV2, so that the buffer BF22 holds the coded stream ST2 corresponding to the moving picture MV2.

Thus, according to Modification 3 of the embodiment, with the timing when sets of the coded data to be held in the memory 361 switch with each other, more and more coded data to be stored in the memory 361 has a non-access bit length smaller than the access bits. Here, in order to generate normal and coded streams ST1 and ST2, the readout and the supplementary data deleting should be executed significantly often.

However, only one memory for storing the data generated by the arithmetic coding unit 351 and only one memory control unit for controlling the memory are provided, so that the circuit scale of the variable length coding unit 300C is smaller than any other circuit scale of the variable length coding units 300, 300A, and 300B.

In other words, the feature successfully reduces the circuit scale of the image coding apparatus 1000C which includes the image coding unit 100C that includes the variable length coding unit 300C.

Hence, the present invention successfully implements an image coding apparatus whose circuit scale is reduced and which performs arithmetic coding and generates multiple kinds of streams.

### [Functional Block Diagram]

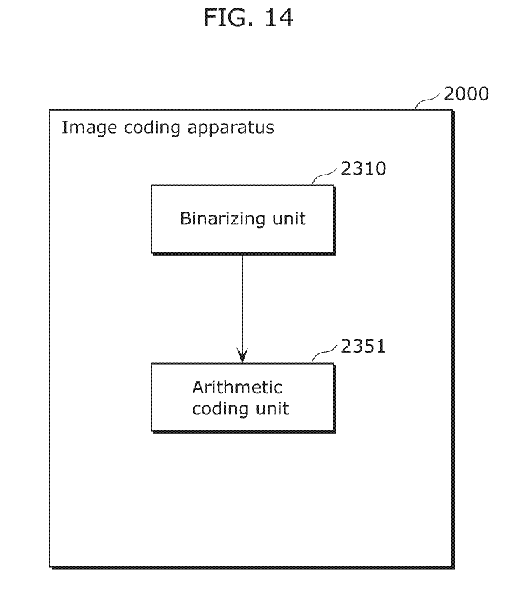

FIG. 14 is a block diagram showing a characteristic functional structure of an image coding apparatus 2000. The image coding apparatus 2000 is one of the image coding apparatuses 1000, 1000A, 1000B, and 1000C.

In other words, FIG. 14 illustrates a block diagram showing essential functions for the present invention among the functions of the image coding apparatuses 1000, 1000A, 1000B, and 1000C.

The image coding apparatus 2000 performs at least the discrete cosine transform, quantization, and arithmetic coding, and processes pieces of the first quantized data and the second quantized data obtained by the quantization.

From a functional viewpoint, the image coding apparatus 2000 includes a binarizing unit 2310 and an arithmetic coding unit 2351.

The binarizing unit 2310 binarizes each of the first quantized data and the second quantized data to generate to generate first binary data and second binary data correspond to the first quantized data and the second quantized data, respectively.

The binarizing unit 2310 corresponds to the binarizing unit 310 in FIGS. 4, 7, 10, and 13.

The arithmetic coding unit 2351 performs arithmetic coding on each of the first binary data and the second binary data to generate a first stream and a second stream correspond to the first binary data and the second binary data, respectively.

The arithmetic coding unit 2351 corresponds to one of the arithmetic coding unit 351 in FIG. 4, the arithmetic coding unit 351 in FIG. 7, the arithmetic coding unit 351A in FIG. 10, and the arithmetic coding unit 351 in FIG. 13.

The image coding apparatus 2000 executes one or both of processing A and processing B.

In the processing A, the binarizing unit 2310 alternately binarizes the first quantized data and the second quantized data, using a time division technique.

In the processing B, the arithmetic coding unit 2351 performs the arithmetic coding alternately on the first binary data and on the second binary data, using the time division technique.

It is noted that part or all of the binarizing unit 2310 and the arithmetic coding unit 2351 may be configured from hardware such as a large scale integration (LSI). Moreover, part or all of the binarizing unit 2310 and the arithmetic coding unit 2351 may be a program module to be executed by a processor such as a central processing unit (CPU).

### Other Modifications

Although only an exemplary embodiment describing the image coding apparatuses 1000, 1000A, 1000B, and 1000C of the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present invention.

The embodiment and Modifications 1 to 3 in the embodiment describe the case where two streams are generated; however, the present invention shall not be limited to the case. The present invention is applicable to the case where three or more streams are generated, as a matter of course. Here, three or more of the paths (structures) may be provided to generate each of the streams.

Furthermore, part or all of the structural elements included in each of the image coding apparatuses 1000, 1000A, 1000B, and 1000C may be configured from hardware. Moreover, part or all of the structural elements included in each of the image coding apparatuses 1000, 1000A, 1000B, and 1000C may be configured from a program module executed by a CPU.

In addition, part or all of the structural elements included in each of the image coding apparatuses 1000, 1000A, 1000B, and 1000C may be configured from a single system LSI.

Furthermore, each of the image coding units 100, 100A, 1008, and 100C may be configured from a single system LSI. Moreover, each of the variable length coding units 300, 300A, 300B, and 300C may be configured from a single system LSI.

The system LSI is a super-multi-function LSI manufactured by integrating constituent units on one chip, and is specifically a computer system configured by including a microprocessor, a read-only memory (ROM), a random-access memory (RAM), or by means of a similar device.

Furthermore, the present invention may be implemented as an image coding method including the operations of the characteristic units, included in each of the image coding apparatuses 1000, 1000A, 1000B, and 1000C, as steps. In addition, the present invention may be implemented as a program to cause a computer to execute each of the steps included in the image coding method. Furthermore, the present invention may be implemented as a computer-readable recording medium which hold the program. In addition, the program may be distributed via a transmission medium such as the Internet.

The disclosed embodiment is an example in all respects, and therefore shall not be defined as it is. The scope of invention shall be defined not by the above descriptions but by claims, and shall include all modifications which are equivalent to and within the scope of the claims.

### INDUSTRIAL APPLICABILITY

The present invention is applicable to an image coding apparatus whose circuit scale is reduced and which performs arithmetic coding and generates multiple kinds of streams.

What is claimed is:

1. An image coding apparatus which performs at least discrete cosine transform, quantization, and arithmetic coding, and processes pieces of first quantized data and pieces of second quantized data obtained by the quantization, said image coding apparatus comprising:
a binarizing unit configured to binarize the pieces of the first quantized data and the pieces of the second quantized data to generate pieces of first binary data and pieces of second binary data, the pieces of the first binary data each corresponding to one of the pieces of the first quantized data and the pieces of the second binary data each corresponding to one of the pieces of the second quantized data; and
an arithmetic coding unit configured to perform arithmetic coding on each of the pieces of the first binary data and each of the pieces of the second binary data to generate a first stream and a second stream corresponding to the pieces of the first binary data and the pieces of the second binary data, respectively,
wherein, in said image coding apparatus, one or both of the binarizing and the arithmetic coding are performed, the binarizing being performed by said binarizing unit alternately on the first quantized data and the second quantized data using a time division technique, and the arithmetic coding being performed by said arithmetic coding unit alternately on the first binary data and the second binary data using the time division technique.

2. The image coding apparatus according to claim 1,
wherein said binarizing unit is configured to alternately binarize the first quantized data and the second quantized data using the time division technique, and
said arithmetic coding unit is configured to perform the arithmetic coding alternately on the first binary data and the second binary data using the time division technique.

3. The image coding apparatus according to claim 1, further comprising
a first memory and a second memory,
wherein said arithmetic coding unit is further configured to
store the first stream and the second stream in said first memory and said second memory, respectively.

4. The image coding apparatus according to claim 3, further comprising
a third memory and a fourth memory,
wherein said binarizing unit is further configured to
store each of the pieces of the first binary data and each of the pieces of the second binary data in said third memory and said fourth memory, respectively, each of the pieces of the first binary data and each of the pieces of the second binary data being subject to the arithmetic coding.

5. The image coding apparatus according to claim 1,
wherein said binarizing unit is configured to alternately binarize the first quantized data and the second quantized data using the time division technique.

6. The image coding apparatus according to claim 1, further comprising
a first memory and a second memory,
wherein said arithmetic coding unit further includes:
a first arithmetic coding unit; and
a second arithmetic coding unit,
said first arithmetic coding unit is configured to perform the arithmetic coding on the pieces of the first binary data to generate the first stream, and to store the generated first stream in said first memory, and
said second arithmetic coding unit is configured to perform arithmetic coding on the pieces of the second binary data to generate the second stream, and to store the generated second stream in said second memory.

7. The image coding apparatus according to claim 1,
wherein the arithmetic coding complies with the H.264/AVC standard,
the binarizing performed by said binarizing unit is based on context-adaptive binary arithmetic coding, and
the arithmetic coding performed by said arithmetic coding unit is binary arithmetic coding based on the context-adaptive binary arithmetic coding.

8. The image coding apparatus according to claim 1,
wherein the first quantized data and the second quantized data are obtained from two different moving pictures.

9. The image coding apparatus according to claim 1,
wherein the first quantized data and the second quantized data are obtained from a same moving picture.

10. An integrated circuit which performs at least discrete cosine transform, quantization, and arithmetic coding, and processes pieces of first quantized data and pieces of second quantized data obtained by the quantization, said integrated circuit comprising:
a binarizing unit configured to binarize the pieces of the first quantized data and the pieces of the second quantized data to generate pieces of first binary data and pieces of second binary data, the pieces of the first binary data each corresponding to one of the pieces of the first quantized data and the pieces of the second binary data each corresponding to one of the pieces of the second quantized data; and
an arithmetic coding unit configured to perform arithmetic coding on each of the pieces of the first binary data and each of the pieces of the second binary data to generate a first stream and a second stream corresponding to the pieces of the first binary data and the pieces of the second binary data, respectively,
wherein, in said integrated circuit one or both of the binarizing and the arithmetic coding are performed,
the binarizing being performed by said binarizing unit alternately on the first quantized data and the second quantized data using a time division technique, and the arithmetic coding being performed by said arithmetic coding unit alternately on the first binary data and the second binary data using the time division technique.
